(19) United States
(12) Patent Application Publication
(10) Pub. No.: US 2024/0086152 A1
(43) Pub. Date: Mar. 14, 2024

(54) CALCULATION UNIT FOR MULTIPLICATION AND ACCUMULATION OPERATIONS

(71) Applicant: STMICROELECTRONICS S.r.l., Agrate Brianza (IT)

(72) Inventors: Luca GANDOLFI, Milano (IT); Ugo GAROZZO, Milano (IT)

(73) Assignee: STMICROELECTRONICS S.r.l., Agrate Brianza (IT)

(21) Appl. No.: 18/453,158

(22) Filed: Aug. 21, 2023

(30) Foreign Application Priority Data
Sep. 8, 2022 (IT) 102022000018330

(51) Int. Cl. G06F 7/544

(52) U.S. Cl. CPC G06F 7/5443

(57) ABSTRACT

A device includes a multiplier, an accumulator and a floating point adder. The multiplier generates a product of a first factor having a sign bit and exponent bits and a second factor having a sign bit and exponent bits. The multiplier includes a sign multiplier and a subtractor. The sign multiplier generates a product of the sign bit of the first factor and the sign bit of the second factor. The subtractor subtracts the exponent bits of the first factor from the exponent bits of the second factor. The accumulator stores a current accumulation value. The floating-point adder is coupled to the multiplier and to the accumulator, and, in operation, the adder generates an updated accumulation value based a sum of the product and the current accumulation value, and stores the updated accumulation value in the accumulator. The first factor may be a weight of a neural network.

### BACKGROUND

### Technical Field

The present disclosure relates to a calculation unit for multiplication and accumulation operations.

### Description of the Related Art

As is known, the iterative repetition of multiplication, sum and accumulation operations of partial results is the basis of different applications, for example in inference processes through neural networks, in filtering or in convolution.

In particular, a neural network comprises a plurality of artificial nodes or neurons organized in layers. Each node has inputs connected to the nodes of a previous adjacent layer (upstream) and an output connected to the nodes of a successive adjacent layer (downstream). The value yᵢ provided at output by each node is obtained by applying an activation function φ, usually a threshold function, to a linear combination of the inputs xⱼ (for example a number D of inputs xⱼ), with a possible bias coefficient or bias b

yᵢ=φ(Σⱼ₌₁^{D}wᵢⱼxⱼ+b) (1)

The output of a layer of the neural network is represented synthetically by an output vector Y̅ given by

Y̅=Φ(WX̅) (2)

where Φ is a vector of the activation functions of the layer nodes, W is a weights matrix wᵢⱼ and X̅ is a vector of the inputs xⱼ.

The coefficients wᵢⱼ of the linear combination are weights characteristic of each node and are determined during a neural network training process.

The calculation of the value yᵢ provided at output by each node is the basis of the functioning of the neural network model, whatever the function provided by the same neural network (for example classification or extraction of characteristics).

From an implementation point of view, it is generally considered convenient to calculate the summation Σⱼ₌₁^{D} wᵢⱼxⱼ+b iteratively, accumulating in a register the results of the products wᵢⱼxⱼ obtained.

The known solutions are however not satisfactory and have limitations for example in terms of execution speed, memory occupied and accuracy of the inferential process. By their nature, in fact, neural networks require considerable amounts of memory to store the weights wᵢⱼ and slow execution times in the absence of optimized solutions.

In addition to the circuits involved in the execution of the calculation operations, the efficiency and accuracy of the neural networks are also affected by the representation chosen for the weights wᵢⱼ.

In quantized neural networks, the weights wᵢⱼ are normally represented with less than 32 bits of the floating-point format “Single-precision floating-point format” often used and a compromise is sought between accuracy and memory occupied. The implementation should also take into account the compatibility of the quantization formats with the addressing modes and the word size of the general purpose processors normally in use in electronic systems. Conversely, the choice of a non-compatible format would pay off with a huge increase in execution times.

For example, it is known to use 8-bit fixed-point formats for the weights wᵢⱼ and the 32-bit floating-point format for the operations, 8-bit pure fixed-point formats and binary formats in combination with the 32-bit floating-point format for the operations. However, the need remains to improve efficiency and accuracy at the same time, to be capable of achieving satisfactory results and allow the profitable use of neural networks in complex applications in real time.

The use of dedicated hardware accelerators has also been proposed, which however require an area not always available on the chips and in any case entails a higher cost per piece.

Similar problems are also present in different applications, for example for filtering and convolution operations.

### BRIEF SUMMARY

In an embodiment, a device comprises a multiplier, an accumulator and a floating-point adder. The multiplier, in operation, generates a product of a first factor having a sign bit and exponent bits and a second factor having a sign bit and exponent bits. The multiplier includes: a sign multiplier, which, in operation, generates a product of the sign bit of the first factor and the sign bit of the second factor; and a subtractor, which, in operation, subtracts the exponent bits of the first factor from the exponent bits of the second factor. The accumulator, in operation, stores a current accumulation value. The floating-point adder is coupled to the multiplier and to the accumulator. The adder, in operation: generates an updated accumulation value based a sum of the product and the current accumulation value; and stores the updated accumulation value in the accumulator.

In an embodiment, a system, comprises a memory and processing circuitry coupled to the memory. The processing circuitry includes a multiply-accumulate circuit. The multiply-accumulate circuit includes a multiplier, an accumulator and a floating-point adder. The multiplier, in operation, generates a product of a first factor having a sign bit and exponent bits and a second factor having a sign bit and exponent bits. The multiplier includes: a sign multiplier, which, in operation, generates a product of the sign bit of the first factor and the sign bit of the second factor; and a subtractor, which, in operation, subtracts the exponent bits of the first factor from the exponent bits of the second factor. The accumulator, in operation, stores a current accumulation value. The floating-point adder is coupled to the multiplier and to the accumulator. The adder, in operation: generates an updated accumulation value based a sum of the product and the current accumulation value; and stores the updated accumulation value in the accumulator.

In an embodiment, a method comprises: multiplying, using a multiplier, a first factor having a sign bit and exponent bits and a second factor having a sign bit and exponent bits, generating a product, wherein the multiplying includes: generating, using an exclusive logic gate, a product of the sign bit of the first factor and the sign bit of the second factor; and subtracting, using a subtractor, the exponent bits of the first factor from the exponent bits of the second factor; storing, in an accumulator, a current accumulation value; and generating, using a floating point adder, an updated accumulation value based a sum of the product and the current accumulation value; and storing the updated accumulation value in the accumulator. In an embodiment, the method comprises storing a plurality of first factors in a memory, the stored plurality of first factors defining node weights of a neural network. In an embodiment, the storing the plurality of first factors in the memory comprises storing N weights of M/N bits in an M-bit word of the memory, M and N being integers greater than 1 and M being an integer multiple of N. In an embodiment, the method comprises: sequentially providing, using a multiplexer, the weights stored in the M-bit word to the multiplier. In an embodiment, the memory is addressable for words of 8 bits and the M-bit word contains two weights of 4 bits.

### BRIEF DESCRIPTION OF THE SEVERAL VIEWS OF THE DRAWINGS

For a better understanding of the disclosure, embodiments thereof will now be described, purely by way of non-limiting example and with reference to the attached drawings, wherein:

FIG. 1 is a simplified block diagram of an electronic system comprising a calculation unit or circuitry in accordance with an embodiment of the present disclosure;

FIG. 2 is a schematic representation of data used by the calculation unit of FIG. 1;

FIG. 3 is a graph showing a quantization scale used by the calculation unit of FIG. 1;

FIG. 4 is a block diagram of an embodiment of a calculation unit that may be employed in FIG. 1;

FIG. 5 is a more detailed block diagram of a portion of the calculation unit of FIG. 1;

FIG. 6 is a block diagram of a calculation unit in accordance with a different embodiment of the present disclosure; and

FIG. 7 is a block diagram of a calculation unit in accordance with a further embodiment of the present disclosure.

### DETAILED DESCRIPTION

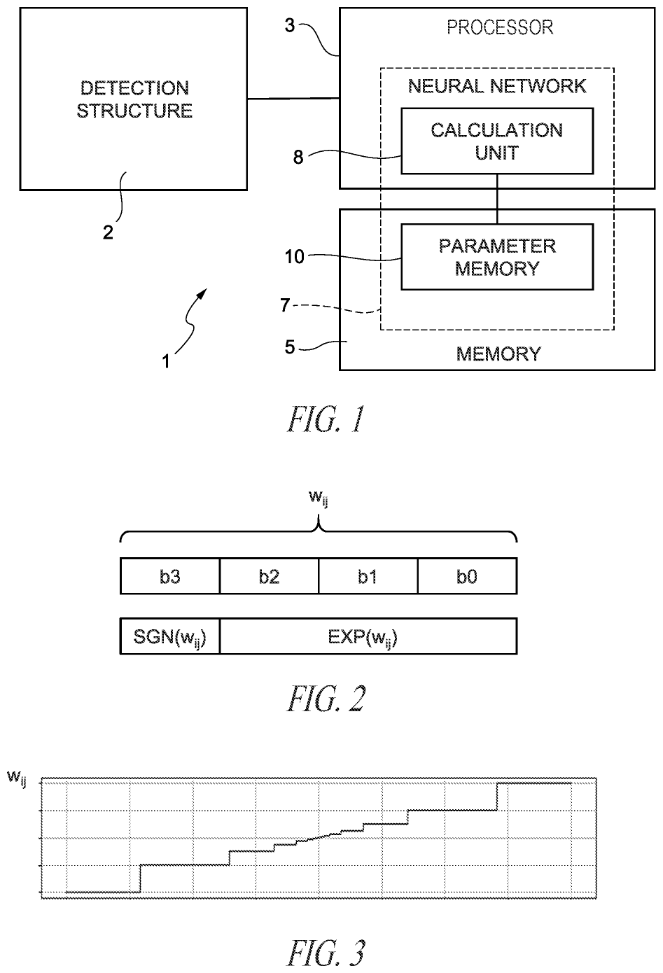

With reference to FIG. 1, a sensor is indicated as a whole with the number 1 and comprises a detection structure 2 (e.g., a MEMS), a processor (processing unit or processing circuitry) 3 and a memory 5. The sensor 1 may be a sensor of any type, for example and not limited to an image sensor, a microelectromechanical inertial sensor, a microelectromechanical pressure sensor, a microelectromechanical electroacoustic sensor. However, the disclosure may be advantageously exploited in any context in which the use of a neural network is convenient or in any way desired, especially in the presence of limited resources in terms of available area and power supply autonomy.

In the embodiment of FIG. 1, a neural network structure 7 comprises components of the processing unit or circuit 3 which define a calculation unit or circuit 8 and a portion of the memory 5 which defines a parameter memory 10. In other embodiments not illustrated, the neural network structure may comprise dedicated circuits and/or components as regards both the calculation unit and the parameter memory. In particular, as in the example of FIG. 1, the calculation components and the memory of the neural network structure may be shared in whole or in part with the processing unit and the system memory. In one embodiment, the processing unit 3 and the memory 5 may be part of a RISC processor, for example of the RISC-V family, and the components of the calculation unit or circuit 8 may comprise standard processor components and dedicated components. Furthermore, the functionalities of the calculation unit or circuit 8 may be called through a RISC instruction.

For the weights, the neural network structure 7 uses a floating-point format with a number of bits equal to an integer fraction of a word bit number. In one embodiment, for example, the memory 5 is addressable by byte and 4 bits, equal to half of a standard 8-bit word, are assigned to each weight, as shown in FIG. 2. In the chosen representation, the most significant bit b3 defines the sign of the weight wᵢⱼ, while the three least significant bits b0-b2 represent the exponent value. The quantization is therefore of the exponential type, as shown in FIG. 3, and the weights wᵢⱼ are defined by

wᵢⱼ=(−1)^{SGN}2^{-Exp} (3)

where SGN is the sign defined by the most significant bit b3 and EXP is the exponent defined by the least significant bits b0-b2. Consequently, the weights wᵢⱼ of the nodes of the neural network structure 7 may assume the values ±2⁰, ±2⁻¹, . . . , ±2⁻⁷.

In one embodiment, the weights are stored sequentially to adjacent memory addresses in the parameter memory 10. In the example described, therefore, each word of the parameter memory 10 contains two weights wᵢⱼ, wᵢⱼ₊₁ to be used in successive iterations. More generally, a word of M bit may contain N weights wᵢⱼ, wᵢⱼ₊₁, . . . , w_{ij+N-1} of M/N bits to be used in N successive iterations, M and N being two integers and M being an integer multiple of N. Alternatively, the memory addresses where the weights are stored may not all be adjacent. For example, the addresses of the weights may comprise blocks of addresses; within each block the addresses are adjacent, while the blocks are not adjacent to each other. The addresses and possibly their grouping into blocks are not necessarily fixed. In successive times, different parts of the memory 5 may be used as parameter memory.

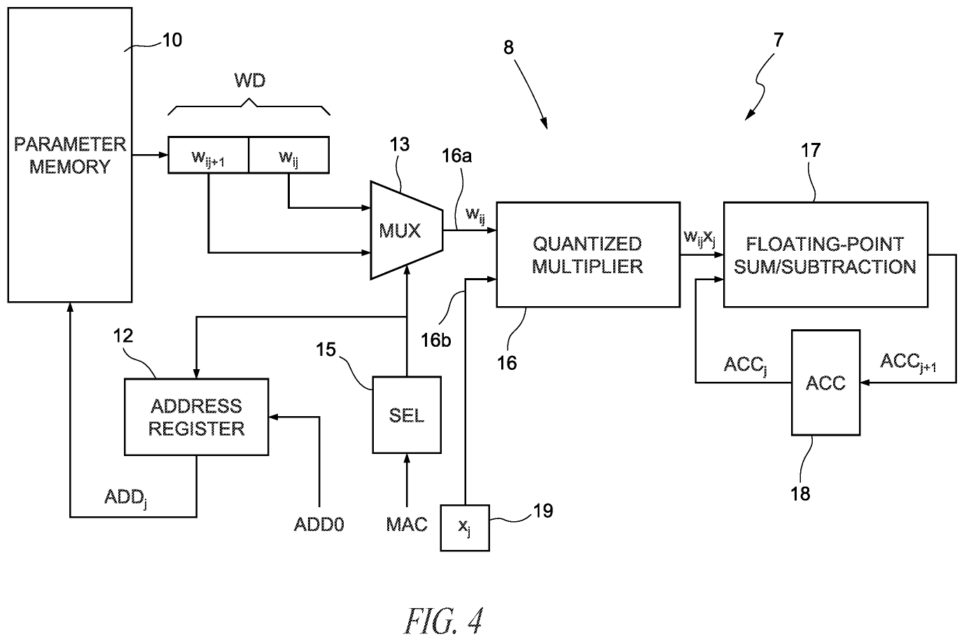

The neural network structure 7 is shown in greater detail in FIG. 4. In particular, the calculation circuitry 8 is configured to operate as a Multiply and Accumulate (MAC) stage and comprises an address register 12, an input multiplexer 13, a selector 15, a quantization multiplier 16, a floating-point sum/subtraction unit or adder 17 and an accumulation register 18.

In one embodiment, the input multiplexer 13 and the quantization multiplier 16 may be defined by dedicated components, while the parameter memory 10, the address register 12, the selector 15, the floating-point sum/subtraction unit 17 and the accumulation register 18 may be standard components of a RISC processor, for example of the RISC-V family.

As already mentioned, the parameter memory 10 may only include adjacent addresses or blocks of addresses, each of which contains adjacent addresses. In the embodiment described herein, the processing unit 3 is part of a RISC processor and the calculation unit 8 may be activated by calling a multiply and accumulate instruction MAC of the RISC processor to perform multiplication and accumulation operations. In this case, in particular, the calculation unit 8 is configured to calculate a product (specifically, of a weight wᵢⱼ for a corresponding input xⱼ), add the product to the content of the accumulation register 18 and update the content of the accumulation register 18 with the result of the sum in response to each call of the multiply and accumulate MAC instruction.

The address register 12 contains a current address ADDⱼ of a memory location where there are stored weights to be used. More precisely, a memory word WD at the current address ADDⱼ is addressed by the address register 12 and, in consideration of the representation in use in the embodiment of FIGS. 1-4, contains a weight wᵢⱼ and a weight wᵢⱼ₊₁ to be used in two consecutive calculation iterations. The address register 12 is accessible in writing, for example by an address management module or circuit not shown of the processing unit 3, to receive an initial address ADD₀ of the first address of the parameter memory 10 (or of one of the blocks that form the parameter memory 10). The content of the address register 12 may be increased to update the current address ADDⱼ by the selector 15, which is configured to switch, in response to each call of the MAC instruction. For example, the selector 15 may have an input 15a receiving a MAC signal correlated to the activation of the MAC instruction. Advantageously, the increase of the current address ADDⱼ is carried out every two calls of the MAC instruction and therefore every two switchings of the selector 15, to use the weights wᵢⱼ, wᵢⱼ₊₁ contained in each memory word WD in two successive iterations, as explained in detail hereinbelow. In the embodiment described herein, the selector 15 may simply be a flip-flop and the increase of the current address ADDⱼ may be carried out when the selector 15 switches from a high logic value to a low logic value.

The input multiplexer 13 receives a word WD from the parameter memory 10 and selectively provides one of the weights contained in the received word WD. More in detail, the input multiplexer 13 has a first input, receiving a first portion WD₀ of the memory word WD containing the weight wᵢⱼ (for example, the four least significant bits) and a second portion WD₁ of the memory word WD containing the weight wᵢⱼ₊₁ (for example, the four most significant bits). The selector 15 controls the input multiplexer 13 so that the first portion WD₀ and the second portion WD₁ of the memory word WD are alternately passed on output in consecutive iterations. In practice, in a first iteration the selector 15 selects the first input and the input multiplexer 13 provides the first portion WD₀ of the memory word WD with the weight wᵢⱼ; in a second consecutive iteration the selector 15 selects the second input and the input multiplexer 13 provides the second portion WD₁ of the memory word WD with the weight wᵢⱼ. Since the content of the address register 12 is increased every two calls of the MAC instruction, each word WD is read twice in two consecutive iterations and the weights wᵢⱼ, wᵢⱼ₊₁ contained respectively in the first portion WD₀ and in the second portion WD₁ are provided in succession on the output of the input multiplexer 13.

The quantization multiplier 16 has a first input 16a receiving the weight wᵢⱼ from the input multiplexer 13 and a second input 16b receiving the corresponding input xⱼ from the processing unit 3 and is configured to calculate the product, wᵢⱼxⱼ, as described in detail below. For example, the input xⱼ may be temporarily stored in an input register 19 of the processing unit 3. More precisely, the inputs xⱼ (j=0, 1, . . . , D) are provided in succession in the input register 19 at each calculation iteration. In practice, every time a weight wᵢⱼ is selected through the input multiplexer 13, a corresponding input xⱼ is made available in the input register 19.

The floating-point sum/subtraction unit 17 receives the product wᵢⱼxⱼ from the quantization multiplier 16 and a current accumulation value ACCⱼ from the accumulation register 18. The floating-point sum/subtraction unit 17 is configured to determine an updated accumulation value ACCⱼ₊₁ by adding the product wᵢⱼxⱼ from the quantization multiplier 16 and the current accumulation value ACCⱼ from the accumulation register 18. The updated accumulation value ACCⱼ₊₁ is stored in the accumulation register 18 in lieu of the current accumulation value ACCⱼ.

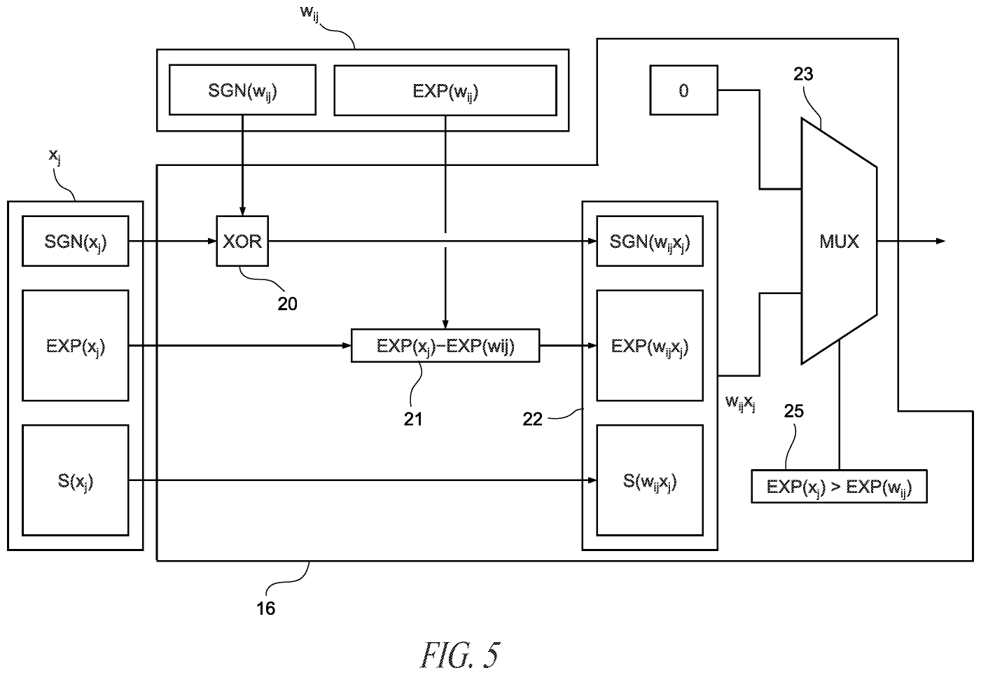

With reference to FIG. 5, the quantization multiplier 16 comprises a sign multiplier 20, a subtractor 21, a result register 22, an output multiplexer 23 and a control logic module or circuit 25.

As already mentioned, the quantization multiplier 16 receives a weight wᵢⱼ from the multiplexer 18 and a corresponding input xⱼ, for example from the input register 19 of the processing unit 3. The input xⱼ has for a part the same format of the weights wᵢⱼ (a sign bit SGN(xⱼ) and an exponent EXP(xⱼ) of three bits in the example described) and also comprises a significant part S(xⱼ) with a number of bits defined according to the design preferences.

The sign multiplier 20, which may be implemented by an exclusive logic gate, for example an XOR or an XNOR gate, receives the sign bit SGN(xⱼ) of the input xⱼ and the sign bit SGN(wᵢⱼ) of the weight wᵢⱼ and provides their product in a sign bit SGN(wᵢⱼxⱼ) of the result register 22.

The subtractor 22 calculates the difference between the exponent EXP(xⱼ) of the input xⱼ and the exponent EXP(wᵢⱼ) of the weight wᵢⱼ. The result of the operation is recorded in the exponent portion EXP(wᵢⱼxⱼ) of the result register 22.

The significant part S(xⱼ) of the input xⱼ is passed directly to the corresponding significant part S(wᵢⱼxⱼ) of the result register 22.

In this manner, the product wᵢⱼxⱼ may be made available by simply using an XOR gate for the sign and a subtractor for the difference of the exponents, avoiding the execution of multiplications in hardware.

The output multiplexer 23 has a first input coupled to the result register 22, to receive the product wᵢⱼxⱼ, a second input receiving a programmed value, for example the value 0, and an output coupled to the floating-point sum/subtraction unit 17.

The control logic module 25 controls the output multiplexer 23 to select the calculated product wᵢⱼxⱼ or the programmed value on the basis of the condition EXP(xⱼ)>EXP(wᵢⱼ). In particular, if the condition occurs, the control logic module 25 selects the calculated product wᵢⱼxⱼ; if, on the other hand, the condition does not occur, the control logic module 25 selects the programmed value 0. In practice, the subnormal numbers are excluded, having negligible values for the applications of interest and which, requiring 0 as the value of the most significant bit instead of 1, would need dedicated circuitry. By excluding them, it may be assumed that the most significant bit (implicit in the floating-point standard) is always 1, saving area.

As already observed, the quantization multiplier 16 may perform the product between a weight wᵢⱼ and the corresponding input xⱼ with an extremely limited number of elementary operations, without having to perform multiplications in hardware. Even the additional components with respect to the RISC architecture have minimal impact in terms of complexity and occupied area.

The multiplication and accumulation procedure may be performed through a single instruction, since, in addition to calculating the products wᵢⱼxⱼ by addition in hardware and accumulation of exponents, the calculation unit 8 automatically provides for the update of the current address of the weights, for the addressing of the parameter memory 10 and for the extraction of the memory word containing the weights from the parameter memory 10.

The disclosure therefore achieves high efficiency without a significant increase in the occupied area, with an evident advantage. Even the quantized four-bit floating-point format chosen for the weights allows the memory space to be used in an efficient manner and ultimately contributes to reducing the occupied area and the execution times. In particular, in the vast majority of cases, the access to memories is carried out by byte. The chosen format adapts to the standard memory access modes and avoids the execution times of the operations being penalized.

Also from the point of view of accuracy, the quantized exponential format used allows satisfactory results to be obtained. Due to the standardization and normalization of the inputs, common in neural networks, the weight distribution is concentrated around zero and, furthermore, the weights have values lower than 1. The exponential quantization, of the type illustrated in FIG. 3, is particularly sensitive right in the value range. Consequently, the accuracy, defined as the number of correct inferences with respect to the total of the tests performed, is very high and comparable with that of the best performing neural network models.

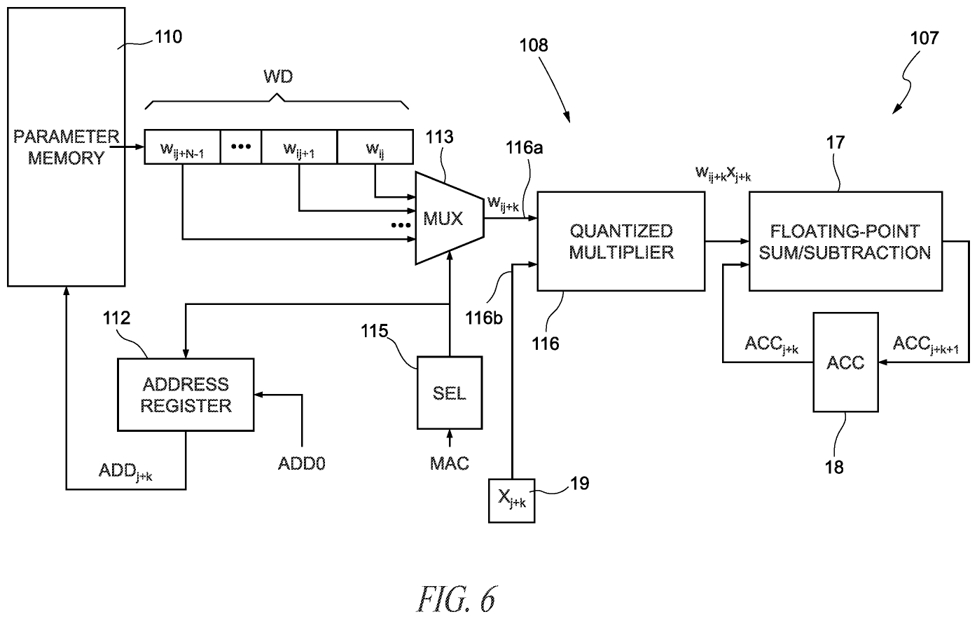

FIG. 6 illustrates a different embodiment of the disclosure, wherein like parts to those already shown are indicated with the same reference numbers. In this case, a neural network structure 107 comprises a calculation unit 108 and a parameter memory 110. The parameter memory 110 has words of M bits, each containing N weights wᵢⱼ, wᵢⱼ₊₁, . . . , w_{ij+N-1} of M/N bits to be used in N successive iterations.

The calculation unit 108 comprises an address register 112, an input multiplexer 113 having N vias, a selector 115, the quantization multiplier 116, the floating-point sum/subtraction unit 17 and the accumulation register 18.

The address register 112 contains a current address ADDⱼ of a memory location where there are stored weights to be used. The address register 112 is accessible in writing, to receive an initial address ADD₀ of the first address of the parameter memory 110 or of one of the blocks that form the parameter memory 110. The content of the address register 12 may be increased to update the current address ADDⱼ by the selector 115, which is configured to switch at each call of the MAC instruction. The increase of the current address ADDⱼ is carried out every N calls of the MAC instruction and therefore every N switchings of the selector 115, to use, in N successive iterations, the weights wᵢⱼ, wᵢⱼ₊₁, . . . , w_{ij+N-1} contained in each memory word WD.

The input multiplexer 113 has inputs receiving respective portions WD₀, WD₁, . . . , WD_{N+1} of the memory word WD. Each portion WD₀, WD₁, . . . , WD_{N+1} contains a respective weight wᵢⱼ, wᵢⱼ₊₁, . . . , w_{ij+N-1} of M/N bits. The selector 115, which may be defined by a module-N counter, controls the input multiplexer 113 so that the portions WD₀, WD₁, . . . , WD_{N+1} of the memory word WD and the weights wᵢⱼ, wᵢⱼ₊₁, . . . , w_{ij+N+1} respectively contained are sequentially passed on output in consecutive iterations.

In practice, in a first iteration the selector 115 selects the first input and the input multiplexer 113 provides the first portion WD₀ of the memory word WD with the weight wᵢⱼ. In a generic k-th successive iteration (k=1, 2, . . . , N−1; in the first iteration, k=0), the selector 115 selects the k-th input and the input multiplexer 113 provides the k-th portion WDₖ of the memory word WD with the weight wᵢⱼ₊ₖ contained therein. Since the content of the address register 112 is increased every N calls of the MAC instruction, each word WD is read N times in N consecutive iterations and the weights wᵢⱼ, wᵢⱼ₊₁, . . . , w_{ij+N-1} respectively contained in the portions WD₀, WD₁, . . . , WD_{N-1} are provided in succession on the output of the input multiplexer 113.

The quantization multiplier 116, except for the number of bits forming the exponent EXP(wᵢⱼ) of the weights wᵢⱼ and the exponent EXP(xⱼ) of the inputs xⱼ, may have the same structure and the same operation already described with reference to FIG. 4.

Also the floating-point sum/subtraction unit 17 and the accumulation register 18 operate substantially as already described with reference to FIG. 4.

In particular, the floating-point sum/subtraction unit 17 receives the product wᵢⱼ₊ₖxⱼ₊ₖ (k=0, 1, . . . , N−1) from the quantization multiplier 116 and a current accumulation value ACCⱼ₊ₖ from the accumulation register 18. The floating-point sum/subtraction unit 17 is configured to determine an updated accumulation value ACCⱼ₊₁ by adding the product wᵢⱼ₊ₖxⱼ₊ₖ from the quantization multiplier 116 and the current accumulation value ACCⱼ₊ₖ from the accumulation register 18. The updated accumulation value ACCⱼ₊ₖ₊₁ is stored in the accumulation register 18 in lieu of the current accumulation value ACCⱼ₊ₖ.

The processing unit 108 of FIG. 6 allows exploiting the same calculation mechanism described for FIGS. 1-5 and may be applied to floating-point quantized exponential formats with a different number of bits for the memory words and for the exponent of the weights.

Advantageously, the number of bits of the weights is an integer fraction of the number of bits of the memory words.

The calculation mechanism may also be exploited for applications other than the inferences of neural network, for example for filtering or convolution operations.

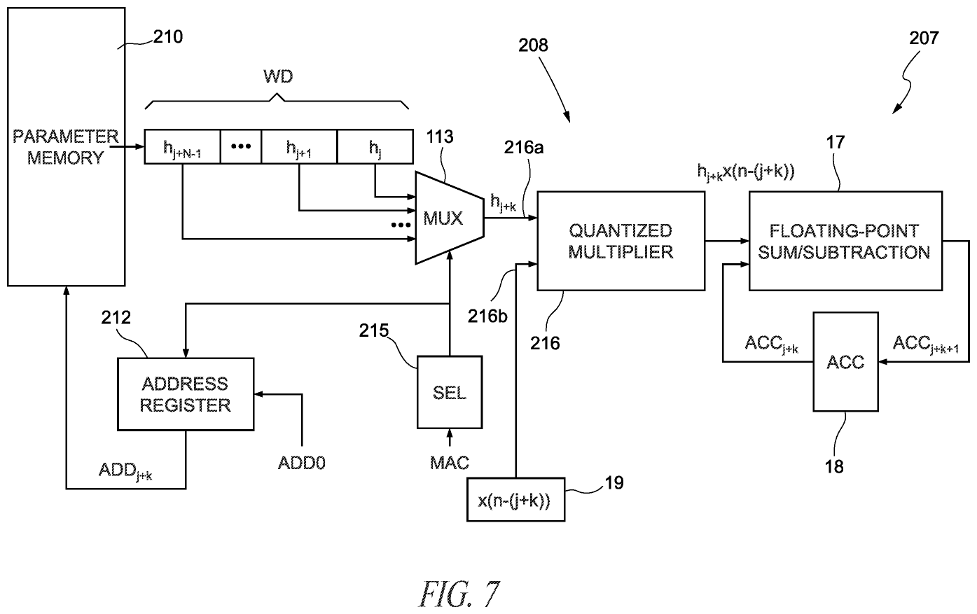

For example, a structure similar to the neural network structure 107 of FIG. 6 is shown in FIG. 7 and may be used to provide a Finite Impulse Response filter or FIR filter 207. In general, the response y(n) of a FIR filter at the discrete time n is given by

y(n)=h₀x(n)+h₁x(n−1)+ . . . +h_{N}x(n−P)=Σⱼ₌₀^{P}hⱼx(n−j) (4)

where P and h₀, . . . , h_{P} are respectively the order and coefficients of the filter and x(n), x(n−N) are the last input samples of the filter. In practice, therefore, the response y(n) is a linear combination of the filter coefficients h₀, . . . , h_{P} and of the last samples x (n), x(n−N) (generically, x(n−j) with j=0, . . . , N) of the input variable. Also in this case, therefore, the result of interest may be determined by multiplication, sum and accumulation operations of partial results. Furthermore, the coefficients h₀, . . . , h_{P} are generally normalized. In applications wherein the normalization produces a bell-shaped distribution (for example a normal distribution) of the coefficients h₀, . . . , h_{P}, the use of a quantized MAC procedure is particularly advantageous.

As shown in FIG. 7, the FIR filter 207 comprises a calculation unit or circuitry 208 and a parameter memory 210. The parameter memory 210 has words WD of M bits, each containing N respective coefficients hⱼ, . . . , h_{j+N-1} of M/N bits to be used in N successive iterations.

The calculation unit 208 comprises an address register 212, an input multiplexer 213 having N vias, a selector 215, the quantization multiplier 216, the floating-point sum/subtraction unit 17 and the accumulation register 18, substantially as already described with reference to FIG. 6. The way of operating is also substantially the same and the result differs in that the content of the words WD and their portions represents the coefficients h₀, . . . , h_{P} of the filter 207 instead of the weights of a neural network.

A calculation unit with the described structure may be advantageously used also in the calculation of vector scalar products, which may be multiplication, sum and accumulation operations of partial results.

Finally, it is clear that modifications and variations may be made to the described calculation unit, without departing from the scope of the present disclosure, as defined in the attached claims.

A calculation unit may be summarized as including a multiplier (16; 116; 216), having a first input (16a; 116a; 216a) configured to receive a first factor (wᵢⱼ; wᵢⱼ₊ₖ; hⱼ) and a second input (16b; 116b; 216b) configured to receive a second factor (xⱼ; xⱼ₊ₖ; x(n−j)), the multiplier (16; 116; 216) being configured to calculate a product (wᵢⱼxⱼ; wᵢⱼ₊ₖxⱼ₊ₖ; hⱼ₊ₖx(n−(j+k))) of the first factor (wᵢⱼ; wᵢⱼ₊ₖ; hⱼ) and of the second factor (xⱼ; xⱼ₊ₖ; x(n−j)); an accumulation memory element (18), containing a current accumulation value (ACCⱼ); and a floating-point sum/subtraction unit (17), coupled to the multiplier (16; 116; 216) and to the accumulation memory element (18) to receive respectively the product (wᵢⱼxⱼ; wᵢⱼ₊ₖxⱼ₊ₖ; hⱼ₊ₖx(n−(j+k))) and the current accumulation value (ACCⱼ) and configured to calculate an updated accumulation value (ACCⱼ₊₁) based on the sum of the product (wᵢⱼxⱼ; wᵢⱼ₊ₖxⱼ₊ₖ; hⱼ₊ₖx(n−(j+k))) and of the current accumulation value (ACCⱼ) and to store the updated accumulation value (ACCⱼ₊₁) in the accumulation memory element (18); wherein the first factor (wᵢⱼ; wᵢⱼ₊ₖ; hⱼ) and the second factor (xⱼ; xⱼ₊ₖ; x(n−j)) each include a respective sign bit (SGN(wᵢⱼ), SGN(xⱼ)) and respective exponent bits (EXP(wᵢⱼ); EXP(xⱼ)).

The multiplier (16) may include a sign multiplier (20), configured to calculate a product of the sign bits (SGN(wᵢⱼ), SGN(xⱼ)) of the first factor (wᵢⱼ; wᵢⱼ₊ₖ) and of the second factor (xⱼ; xⱼ₊ₖ), and a subtractor (21), configured to receive the exponent bits (EXP(wᵢⱼ); EXP(xⱼ)) of the first factor (wᵢⱼ; wᵢⱼ₊ₖ) and of the second factor (xⱼ; xⱼ₊ₖ) and to subtract the exponent bits (EXP(wᵢⱼ)) of the first factor (wᵢⱼ; wᵢⱼ₊ₖ) from the exponent bits (EXP(xⱼ)) of the second factor (xⱼ; xⱼ₊ₖ).

The sign multiplier (20) may include an exclusive logic gate, receiving the sign bits (SGN(wᵢⱼ), SGN(xⱼ)) of the first factor (wᵢⱼ; wᵢⱼ₊ₖ) and of the second factor (xⱼ; xⱼ₊ₖ) and providing the product of the sign bits (SGN(wᵢⱼ), SGN(xⱼ)) of the first factor (wᵢⱼ; wᵢⱼ₊ₖ) and of the second factor (xⱼ; xⱼ₊ₖ).

The multiplier (16) may include a result register (22) and the sign multiplier (20) may be configured to store the product of the sign bits (SGN(wᵢⱼ), SGN(xⱼ)) of the first factor (wᵢⱼ; wᵢⱼ₊ₖ) and of the second factor (xⱼ; xⱼ₊ₖ) in a sign bit (SGN (wᵢⱼxⱼ)) of the result register (22).

The subtractor (21) may be configured to store a difference between the exponent bits (EXP (xⱼ)) of the second factor (xⱼ; xⱼ₊ₖ) and the exponent bits (EXP(wᵢⱼ)) of the first factor (wᵢⱼ; wᵢⱼ₊ₖ) in an exponent portion (EXP(wᵢⱼxⱼ)) of the result register (22).

The second factor (xⱼ; xⱼ₊ₖ) may include significant part bits (S(xⱼ)) and the multiplier (16) may be configured to store the significant part bits (S(xⱼ)) of the second factor (xⱼ; xⱼ₊ₖ) in corresponding significant part bits (S(wᵢⱼxⱼ)) of the result register (22).

The multiplier (16) may include an output multiplexer (23), having a first input coupled to the result register (22), to receive the product of the sign bits (SGN(wᵢⱼ), SGN(xⱼ)) of the first factor (wᵢⱼ; wᵢⱼ₊ₖ) and of the second factor (xⱼ; xⱼ₊ₖ), a second input configured to receive a programmed value, and an output coupled to the floating-point sum/subtraction unit (17); and a control logic module (25) configured to control the output multiplexer (23) so as to select the product of the sign bits (SGN(wᵢⱼ), SGN(xⱼ)) of the first factor (wᵢⱼ; wᵢⱼ₊ₖ) and of the second factor (xⱼ; xⱼ₊ₖ) or the programmed value on the basis of a relationship between the first factor (wᵢⱼ; wᵢⱼ₊ₖ) and the second factor (xⱼ; xⱼ₊ₖ).

The control logic module (25) may be configured to control the output multiplexer (23) so as to select the product of the sign bits (SGN(wᵢⱼ), SGN(xⱼ)) of the first factor (wᵢⱼ; wᵢⱼ₊ₖ) and of the second factor (xⱼ; xⱼ₊ₖ) when a first exponent defined by the exponent bits (EXP (wᵢⱼ)) of the first factor (wᵢⱼ; wᵢⱼ₊ₖ) and may be smaller than a second exponent defined by the exponent bits (EXP (xⱼ)) of the second factor (xⱼ; xⱼ₊ₖ) and select the programmed value when the first exponent is greater than the second exponent.

A neural network structure, may be summarized as including a calculation unit (8; 108).

The neural network structure may include a parameter memory (10; 110) containing a plurality of first factors (wᵢⱼ; wᵢⱼ₊ₖ), defining node weights of a neural network.

The parameter memory (10; 110) may be addressable for words (WD) of M bits and each word (WD) contains N weights (wᵢⱼ, wᵢⱼ₊₁, . . . , w_{ij+N-1}) of M/N bits, M and N being integers and M being an integer multiple of N; and the calculation unit (8; 108) may include an input multiplexer (13; 113) configured to receive one of the words (WD) from the parameter memory (10; 110) and selectively provide one of the weights (wᵢⱼ, wᵢⱼ₊₁, . . . . w_{ij+N-1}) to the multiplier (16).

The calculation unit (8; 108) may include a selector (15; 115) configured to control the input multiplexer (13; 113) so that the weights (wᵢⱼ, w_{ij+N-1}) contained in the word (WD) received by the input multiplexer (13; 113) are sequentially passed on output by the input multiplexer (13; 113).

The calculation unit (8; 108) may include an address register (12; 112) containing a current address (ADDⱼ) of the word (WD) containing the weights (wᵢⱼ, w_{ij+N-1}) to be provided to the input multiplexer (13; 113); and the selector (15; 115) may be configured to control the input multiplexer (13; 113).

The parameter memory (10) may be addressable for words (WD) of 8 bits and each word (WD) may contain two weights (wᵢⱼ, wᵢⱼ₊₁) of 4 bits; and the input multiplexer (13) may have a first input, receiving a first portion (WD₀) of the memory word (WD), containing a first one of the weights (wᵢⱼ), and a second portion (WD₁) of the memory word (WD), containing a second one of the weights (wᵢⱼ₊₁).

The weights (wᵢⱼ, wᵢⱼ₊₁) may be stored in words (WD) at consecutive addresses of the parameter memory (10; 110).

In an embodiment, a device comprises a multiplier, an accumulator and a floating-point adder. The multiplier, in operation, generates a product of a first factor having a sign bit and exponent bits and a second factor having a sign bit and exponent bits. The multiplier includes: a sign multiplier, which, in operation, generates a product of the sign bit of the first factor and the sign bit of the second factor; and a subtractor, which, in operation, subtracts the exponent bits of the first factor from the exponent bits of the second factor. The accumulator, in operation, stores a current accumulation value. The floating-point adder is coupled to the multiplier and to the accumulator. The adder, in operation: generates an updated accumulation value based a sum of the product and the current accumulation value; and stores the updated accumulation value in the accumulator.

In an embodiment, the sign multiplier comprises an exclusive logic gate. In an embodiment, the multiplier comprises a result register, which, in operation, stores the product of the sign bit of the first factor and the sign bit of the second factor in a sign bit of the result register. In an embodiment, the subtractor, in operation, stores a difference between the exponent bits of the second factor and the exponent bits of the first factor in an exponent portion of the result register. In an embodiment, the second factor includes significant part bits and, in operation, the multiplier stores the significant part bits of the second factor in a significant part bits portion of the result register. In an embodiment, the multiplier comprises: an output multiplexer, having a first input coupled to the result register to receive the product of the sign bits of the first factor and the second factor, a second input to receive a programmed value, and an output coupled to the floating-point adder; and control logic, which, in operation, controls the output multiplexer to select the product of the sign bits of the first factor and the second factor or the programmed value based on a relationship between the first factor and the second factor. In an embodiment, the control logic controls the output multiplexer to select the product of the sign bits of the first factor and the second factor when a first exponent defined by the exponent bits of the first factor is smaller than a second exponent defined by the exponent bits of the second factor, and to select the programmed value when the first exponent is greater than the second exponent.

In an embodiment, a system, comprises a memory and processing circuitry coupled to the memory. The processing circuitry includes a multiply-accumulate circuit. The multiply-accumulate circuit includes a multiplier, an accumulator and a floating-point adder. The multiplier, in operation, generates a product of a first factor having a sign bit and exponent bits and a second factor having a sign bit and exponent bits. The multiplier includes: a sign multiplier, which, in operation, generates a product of the sign bit of the first factor and the sign bit of the second factor; and a subtractor, which, in operation, subtracts the exponent bits of the first factor from the exponent bits of the second factor. The accumulator, in operation, stores a current accumulation value. The floating-point adder is coupled to the multiplier and to the accumulator. The adder, in operation: generates an updated accumulation value based a sum of the product and the current accumulation value; and stores the updated accumulation value in the accumulator.

In an embodiment, the processing circuitry, in operation, implements a neural network using the multiply-accumulate circuit. In an embodiment, the memory, in operation, stores a plurality of first factors, the first factors defining node weights of the neural network. In an embodiment, the memory is addressable for words of M bits and a word of the memory stores a plurality of N weights of M/N bits, M and N being integers and M being an integer multiple of N; and the multiply-accumulate circuit comprises an input multiplexer, which, in operation, receives the word and selectively provide one of the weights stored in the word to the multiplier. In an embodiment, the multiply-accumulate circuit comprises a selector, which, in operation, controls the input multiplexer so that the weights stored in the word received by the input multiplexer are sequentially passed on output by the input multiplexer. In an embodiment, the multiply-accumulate circuit comprises an address register containing a current address of the word containing the weights to be provided to the input multiplexer. In an embodiment, the memory is addressable for words of 8 bits and the word contains two weights of 4 bits; and the input multiplexer has a first input, which, in operation, receives a first portion of the word containing a first one of the weights, and a second input, which, in operation, receives a second portion of the word, the second portion of the word containing a second one of the weights. In an embodiment, the weights are stored in a plurality of words at consecutive addresses of the memory. In an embodiment, the system comprises a detection structure coupled to the processing circuitry, wherein processing circuitry generates the second factor based on an output of the detection structure.

In an embodiment, a method comprises: multiplying, using a multiplier, a first factor having a sign bit and exponent bits and a second factor having a sign bit and exponent bits, generating a product, wherein the multiplying includes: generating, using an exclusive logic gate, a product of the sign bit of the first factor and the sign bit of the second factor; and subtracting, using a subtractor, the exponent bits of the first factor from the exponent bits of the second factor; storing, in an accumulator, a current accumulation value; and generating, using a floating point adder, an updated accumulation value based a sum of the product and the current accumulation value; and storing the updated accumulation value in the accumulator. In an embodiment, the method comprises storing a plurality of first factors in a memory, the stored plurality of first factors defining node weights of a neural network. In an embodiment, the storing the plurality of first factors in the memory comprises storing N weights of M/N bits in an M-bit word of the memory, M and N being integers greater than 1 and M being an integer multiple of N. In an embodiment, the method comprises: sequentially providing, using a multiplexer, the weights stored in the M-bit word to the multiplier. In an embodiment, the memory is addressable for words of 8 bits and the M-bit word contains two weights of 4 bits.

Some embodiments may take the form of or comprise computer program products. For example, according to one embodiment there is provided a computer readable medium comprising a computer program adapted to perform one or more of the methods or functions described above. The medium may be a physical storage medium, such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the methods and/or functionality may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
a multiplier, which, in operation, generates a product of a first factor having a sign bit and exponent bits and a second factor having a sign bit and exponent bits, wherein the multiplier includes:
a sign multiplier, which, in operation, generates a product of the sign bit of the first factor and the sign bit of the second factor; and
a subtractor, which, in operation, subtracts the exponent bits of the first factor from the exponent bits of the second factor;
an accumulator, which, in operation, stores a current accumulation value; and
a floating-point adder coupled to the multiplier and to the accumulator, wherein the adder, in operation:
generates an updated accumulation value based a sum of the product and the current accumulation value; and
stores the updated accumulation value in the accumulator.

2. The device according to claim 1, wherein the sign multiplier comprises an exclusive logic gate.

3. The device according to claim 2, wherein the multiplier comprises a result register, and wherein the sign multiplier, in operation, stores the product of the sign bit of the first factor and the sign bit of the second factor in a sign bit of the result register.

4. The device according to claim 3, wherein the subtractor, in operation, stores a difference between the exponent bits of the second factor and the exponent bits of the first factor in an exponent portion of the result register.

5. The device according to claim 3, wherein the second factor includes significant part bits and, in operation, the multiplier stores the significant part bits of the second factor in a significant part bits portion of the result register.

6. The device according to claim 3, wherein the multiplier comprises:
an output multiplexer, having a first input coupled to the result register to receive the product of the sign bits of the first factor and the second factor, a second input to receive a programmed value, and an output coupled to the floating-point adder; and
control logic, which, in operation, controls the output multiplexer to select the product of the sign bits of the first factor and the second factor or the programmed value based on a relationship between the first factor and the second factor.

7. The device according to claim 6, wherein the control logic controls the output multiplexer to select the product of the sign bits of the first factor and the second factor when a first exponent defined by the exponent bits of the first factor is smaller than a second exponent defined by the exponent bits of the second factor and to select the programmed value when the first exponent is greater than the second exponent.

8. A system, comprising:
a memory; and
processing circuitry coupled to the memory, wherein the processing circuitry includes a multiply-accumulate circuit, the multiply-accumulate circuit including:
a multiplier, which, in operation, generates a product of a first factor having a sign bit and exponent bits and a second factor having a sign bit and exponent bits, wherein the multiplier includes:
a sign multiplier, which, in operation, generates a product of the sign bit of the first factor and the sign bit of the second factor; and
a subtractor, which, in operation, subtracts the exponent bits of the first factor from the exponent bits of the second factor;
an accumulator, which, in operation, stores a current accumulation value; and
a floating-point adder coupled to the multiplier and to the accumulator, wherein the adder, in operation:
generates an updated accumulation value based a sum of the product and the current accumulation value; and
stores the updated accumulation value in the accumulator.

9. The system according to claim 8, wherein the processing circuitry, in operation, implements a neural network using the multiply-accumulate circuit.

10. The system according to claim 9, wherein the memory, in operation, stores a plurality of first factors, the first factors defining node weights of the neural network.

11. The system according to claim 10, wherein,
the memory is addressable for words of M bits and a word of the memory stores a plurality of N weights of M/N bits, M and N being integers and M being an integer multiple of N; and
the multiply-accumulate circuit comprises an input multiplexer, which, in operation, receives the word and selectively provide one of the weights stored in the word to the multiplier.

12. The system according to claim 11, wherein the multiply-accumulate circuit comprises a selector, which, in operation, controls the input multiplexer so that the weights stored in the word received by the input multiplexer are sequentially passed on output by the input multiplexer.

13. The system according to claim 12, wherein the multiply-accumulate circuit comprises an address register containing a current address of the word containing the weights to be provided to the input multiplexer.

14. The system according to claim 13, wherein
the memory is addressable for words of 8 bits and the word contains two weights of 4 bits; and
the input multiplexer has a first input, which, in operation, receives a first portion of the word containing a first one of the weights, and a second input, which, in operation, receives a second portion of the word, containing a second one of the weights.

15. The system according to claim 11, wherein the weights are stored in a plurality of words at consecutive addresses of the memory.

16. The system of claim 8, comprising:
a detection structure coupled to the processing circuitry, wherein processing circuitry generates the second factor based on an output of the detection structure.

17. A method, comprising:
multiplying, using a multiplier, a first factor having a sign bit and exponent bits and a second factor having a sign bit and exponent bits, generating a product, wherein the multiplying includes:
generating, using an exclusive logic gate, a product of the sign bit of the first factor and the sign bit of the second factor; and
subtracting, using a subtractor, the exponent bits of the first factor from the exponent bits of the second factor;
storing, in an accumulator, a current accumulation value; and
generating, using a floating point adder, an updated accumulation value based a sum of the product and the current accumulation value; and
storing the updated accumulation value in the accumulator.

18. The method according to claim 17, comprising storing a plurality of first factors in a memory, the stored plurality of first factors defining node weights of a neural network.

19. The method according to claim 18, wherein the storing the plurality of first factors in the memory comprises storing N weights of M/N bits in an M-bit word of the memory, M and N being integers greater than 1 and M being an integer multiple of N.

20. The method according to claim 19, comprising:
sequentially providing, using a multiplexer, the weights stored in the M-bit word to the multiplier.
